(19) United States
(12) Patent Application Publication
(10) Pub. No.: US 2014/0353392 A1
(43) Pub. Date: Dec. 4, 2014

(54) HEATING SYSTEM FOR ELECTRIC VEHICLE

(71) Applicant: Hyundai Motor Company, Seoul (KR)

(72) Inventors: June Kyu Park, Hwaseong-si (KR); Yong Soo CHANG, Seoul (KR); Bock Cheol LEE, Suwon-si (KR); Yong Joo CHO, Seoul (KR)

(73) Assignee: Hyundai Motor Company, Seoul (KR)

(21) Appl. No.: 14/137,976

(22) Filed: Dec. 20, 2013

(30) Foreign Application Priority Data
Jun. 3, 2013 (KR) 10-2013-0063709

(51) Int. Cl. B60H 1/00; B60H 1/14

(52) U.S. Cl. CPC B60H 1/00885; B60H 1/143
USPC 237/12.3 B; 165/41; 237/44

(57) ABSTRACT

A heating system for an electric vehicle heats an interior thereof by the driving force of a drive motor is activated by battery power, and includes: a heat exchanger that is connected to the drive motor via a cooling line circulating cooling water between the battery and the drive motor; a PTC connected to the battery via the cooling line and activated by battery power; a heat storage unit that collects and stores thermal energy from the cooling water, with its temperature raised while cooling the drive motor, and connected in series to the drive motor and the battery via the cooling line; and a valve unit installed in the cooling line interconnecting the drive motor, the heat exchanger, and the heat storage unit, which selectively connects the cooling line to the drive motor, the heat exchanger, and the heat storage unit by opening and closing operations.

### CROSS-REFERENCE TO RELATED APPLICATION

The present application claims priority of Korean Patent Application Number 10-2013-0063709 filed Jun. 3, 2013, the entire contents of which application is incorporated herein for all purposes by this reference.

### BACKGROUND OF INVENTION

1. Field of Invention

The present invention relates to a heating system for an electric vehicle which improves overall heating efficiency depending on the vehicle's driving condition and which mode the user selects.

2. Description of Related Art

In general, a vehicle's air conditioning system allows passengers to feel comfortable in any particular climate and driving conditions. Particularly, the heating mode of the air conditioning system allows the driver to drive comfortably and safely, by warming up the air inside the vehicle, and preventing the windows from getting cloudy or steamy due to condensation.

The heating mode employs a hot-water heater that uses heat generated from the engine while driving. In this mode, the outside air introduced through an air intake duct rises in temperature as it passes through the hot-water heater, and is blown into the vehicle via a defroster and a duct for blowing air into the inside by means of a blower.

Meanwhile, energy efficiency and environmental pollution are of increasing concern, and this creates demand for the development of environmentally-friendly vehicles substituting vehicles having an internal combustion engine. Such environmentally-friendly vehicles include electric vehicles using fuel cell or electricity as a power source, or hybrid vehicles driven by an engine and an electric battery.

In an air conditioning system of an electric vehicle among the environmentally-friendly vehicle, heat exchange is performed between cooling water, with its temperature raised by the heat of a motor that is driven as a substitute for the engine, and air for use in indoor heating. Therefore, heating is activated when the engine temperature has risen after a lapse of 5 to 10 minutes after startup.

Accordingly, an additional heat source is installed in the vehicle for heating at the initial stage of the startup, and used as an auxiliary heat source.

That is, hot wire is provided on the outlet portion of a duct through which outside air comes into the vehicle, or an auxiliary heater is installed and used until the indoor temperature rises by heating the engine.

However, in the case of a conventional electric vehicle in which the rapid heating system for the initial stage of startup is not employed, drivers in winter have to drive for a certain amount of time when the temperature inside the vehicle is still low, after he or she gets into the vehicle, or have to wait for a certain amount of time after starting the engine.

In addition, warming up the electric vehicle leads to excessive electricity consumption, raises the manufacturing cost due to the hot wire or auxiliary heater, and increases the amount of electricity used for actuating the hot wire or auxiliary heater, thereby causing the electric vehicle to travel a shorter distance and resulting in a fuel rate reduction.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a heating system for an electric vehicle which improves the overall heating efficiency of the electric vehicle by storing the heat of cooling water having a raised temperature due to a drive motor, and using the heat for heating, depending on the vehicle's driving condition and which mode the user selects, thereby eliminating unnecessary power use and resulting in an increased fuel rate.

Various aspects of the present invention provide for a heating system for an electric vehicle, which heats the inside of the electric vehicle running by the driving force of a drive motor that is activated by power supplied from a battery, the heating system including: a heating heat exchanger that is connected to the drive motor via a cooling line through which cooling water circulates between the battery and the drive motor; a positive temperature coefficient heater (PTC) that is connected to the battery via the cooling line and activated by the power of the battery; a heat storage unit that collects and stores thermal energy from the cooling water, with its temperature raised while cooling down the drive motor, and connected in series to the drive motor and the battery via the cooling line; and a valve unit that is installed in the cooling line interconnecting the drive motor, the heating heat exchanger, and the heat storage unit, and selectively connects the cooling line to the drive motor, the heating heat exchanger, and the heat storage unit by opening and closing operations.

The cooling line may include: a first line that is connected to the valve unit and interconnects the drive motor and the heating heat exchanger; a second line that interconnects the battery and the PTC; a third line that is connected to the valve unit and interconnects the drive motor and the heat storage unit; and a fourth line that interconnects the battery and the heat storage unit.

The valve unit may consist of a 3-way valve that interconnects the first line and the third line.

The valve unit may include: a main body including a first open hole that is connected to the drive motor through the first line so as to be connected to the drive motor, the heating heat exchanger, and the heat storage unit, a second open hole that is connected to the heating heat exchanger through the second line, and a third open hole that is connected to the heat storage unit through the third line; and an opening and closing member that is rotatably configured so as to selectively open and close the open holes within the main body.

The second open hole and the third open hole may be positioned on both ends of the main body, and the first open hole may be positioned at a middle portion of the main body, between the first open hole and the third open hole.

The opening and closing member may include: a rotation part rotatably formed in the middle within the main body; and a fan-shaped opening and closing part, one edge of which is connected integrally to a side of the rotation part, and the other edge of which selectively opens and closes the open holes.

A rounded part disposed on the opposite side of the first open hole, corresponding to the other edge of the opening and closing part, may be formed integrally with the main body.

The lateral length D of the other edge of the opening and closing part may be equal to the width W of the opening holes (D=W).

As described above, the heating system for the electric vehicle according to various aspects of the present invention can improve the overall heating efficiency of the electric vehicle by storing the heat of cooling water having a raised temperature due to a drive motor, and using the heat for heating, depending on the vehicle's driving condition and which mode the user selects.

In addition, the use of a stored heat source can simplify the entire system by reducing the components, cut down on manufacturing costs, and prevent unnecessary power use, even without including an auxiliary heater, thereby improving the overall fuel rate and driving distance of the electric vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary heating system for an electric vehicle according to the present invention.

FIG. 2 is a transparent perspective view of a valve unit applied to the exemplary heating system for the electric vehicle according to the present invention.

FIG. 3 is a table showing the operation of the exemplary heating system for the electric vehicle according to the present invention.

FIG. 4 is a view showing the operating condition of the exemplary heating system for the electric vehicle according to the present invention during programmed air-conditioning.

FIG. 5 is a view showing the operating condition of the exemplary heating system for the electric vehicle according to the present invention during the initial stage of driving.

FIG. 6 is a view showing the operating condition of the exemplary heating system for the electric vehicle according to the present invention during high-speed driving.

FIG. 7 is a view showing the operating condition of the exemplary heating system for the electric vehicle according to the present invention during IDLE.

FIG. 8 is a view showing the operating condition of the exemplary heating system for the electric vehicle according to the present invention during full heating.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

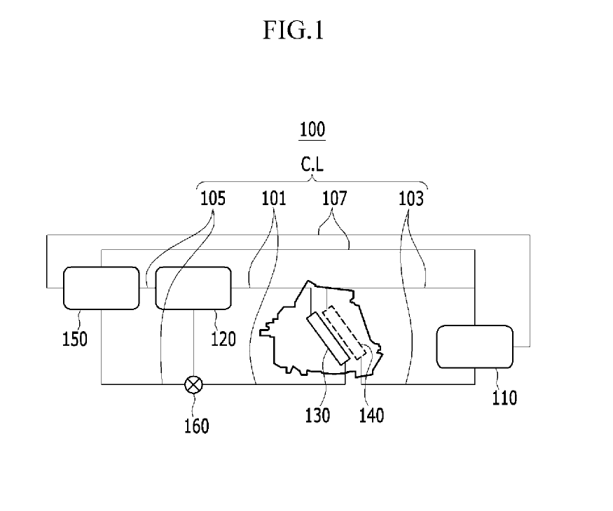

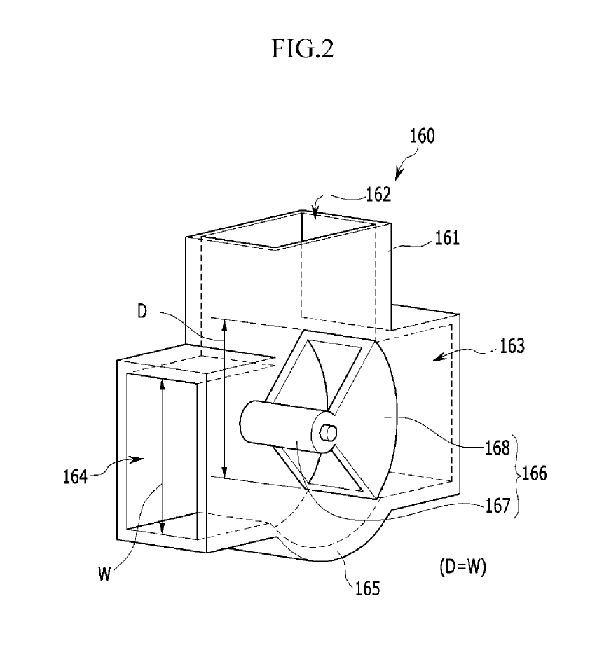

FIG. 1 is a block diagram of a heating system for an electric vehicle according to various embodiments of the present invention. FIG. 2 is a transparent perspective view of a valve unit applied to the heating system for the electric vehicle according to various embodiments of the present invention.

Referring to the drawings, the heating system 100 for the electric vehicle according to various embodiments of the present invention is configured to improve the overall heating efficiency of the electric vehicle by storing the heat of cooling water having a raised temperature due to a drive motor 120, and selectively supplying the heat to a heating heat exchanger 130 for use in heating, depending on the vehicle's driving condition and which mode the user selects, thereby eliminating unnecessary power use and resulting in an increased fuel rate.

To this end, the heating system 100 for the electric vehicle according to various embodiments of the present invention is for heating the inside of an electric vehicle that runs on the torque of a drive motor 120 activated by power supplied from a battery 110. As shown in FIG. 1, the heating system 100 includes the heating heat exchanger 130, a positive temperature coefficient heater (PTC) 140, a heat storage unit 150, and the valve unit 160.

First of all, the heating heat exchanger 130 and the drive motor 120 are interconnected via a cooling line (hereinafter, ‘C.L’) along which cooling water circulates between the battery 110 and the drive motor 120.

Depending on conditions, such as when the temperature of cooling water entering the heating heat exchanger 130 is low or when full heating is required, the PTC 140 is activated by the power of the battery 100 to cause outside air having a raised temperature by heat exchange to enter the inside of the vehicle while passing, and the PTC 140 is connected to the battery via the C.L.

In the present exemplary embodiment, the heat storage unit 150 collects and stores thermal energy from cooling water with its temperature raised while cooling down the drive motor 120 that drives the electric vehicle, and is connected in series to the drive motor 120 and the battery 110, respectively, via the C.L.

As a phase-change material inside the heat storage unit 150 undergoes a phase change, the heat storage unit 150 stores thermal energy from a waste heat generated while the electric vehicle is running, and makes efficient use of the stored thermal energy in warming up and indoor heating during the initial startup of the vehicle.

In this case, the heat storage unit 150 may include the function of heating an inductive material by power supplied from the battery 110.

The valve unit 160 is installed in the C.L interconnecting the drive motor 120, the heating heat exchanger 130, and the heat storage unit 150, and selectively connects the C.L to the drive motor 120, the heating heat exchanger 130, and the heat storage unit 150 by opening and closing operations.

The valve unit 160 is selectively connected to the C.L in order to control the flow of cooling water. The structure and operation of the valve unit 160 will be described in detail below.

In the present exemplary embodiment, the C.L includes a first line 101 that is connected to the valve unit 160 and interconnects the drive motor 120 and the heating heat exchanger 130, a second line 103 that interconnects the battery 110 and the PTC 140, and a third line 105 that is connected to the valve unit 160 and interconnects the drive motor 120 and the heat storage unit 150.

Further, the C.L further includes a fourth line 107 that interconnects the battery 110 and the heat storage unit 150.

That is, the second line 105 circulates cooling water by interconnecting the battery 110 and the PTC 140, and the fourth line 107 circulates the cooling water whose temperature has risen as it passes through the battery 110, and stores thermal energy.

In this case, the valve unit 160 can interconnect the first line 101 and the third line 105.

In the present exemplary embodiment, the valve unit 160 includes a main body 161 and an opening and closing member 166, as shown in FIG. 2.

First of all, the main body 161 includes a first open hole 162 that is connected to the drive motor 120 through the first line 101 so as to be connected to the drive motor 120, the heating heat exchanger 130, and the heat storage unit 150, a second open hole 163 that is connected to the heating heat exchanger 130 through the second line 103, and a third open hole 164 that is connected to the heat storage unit 150 through the third line 105.

The second open hole 163 and the third open hole 164 may be positioned on both ends of the main body 161, and the first open hole 162 may be positioned at a middle portion of the main body 161, between the first open hole 162 and the third open hole 164.

The main body 161 forms an overall T-shape.

The opening and closing member 166 is rotatably configured so as to selectively open and close the open holes 162, 163, and 164 within the main body 161.

The opening and closing member 166 includes a rotation part 167 rotatably formed in the middle within the main body 161, and a fan-shaped opening and closing part 168, one edge of which is connected integrally to a side of the rotation part 167, and the other edge of which selectively opens and closes the open holes 162, 163, and 164. One will appreciate that such integral components may be monolithically formed.

In the present exemplary embodiment, the lateral length D of the other edge of the opening and closing part 168 may be equal to the width W of the opening holes 162, 163, and 164 (D=W).

A rounded part 165 disposed on the opposite side of the first open hole 162, corresponding to the other edge of the opening and closing part 168, may be formed integrally with the main body 161. One will appreciate that such integral components may be monolithically formed.

That is, the thus-configured valve unit 160 is adapted to control the movement direction of cooling water moving along the C. as the opening and closing member 166 is rotated within the main body 161 in response to a control signal from ECU and interconnects the open holes 162, 163, and 164.

Hereinafter, the operation and effects of the heating system 100 for the electric vehicle according to various embodiments of the present invention will be described in detail.

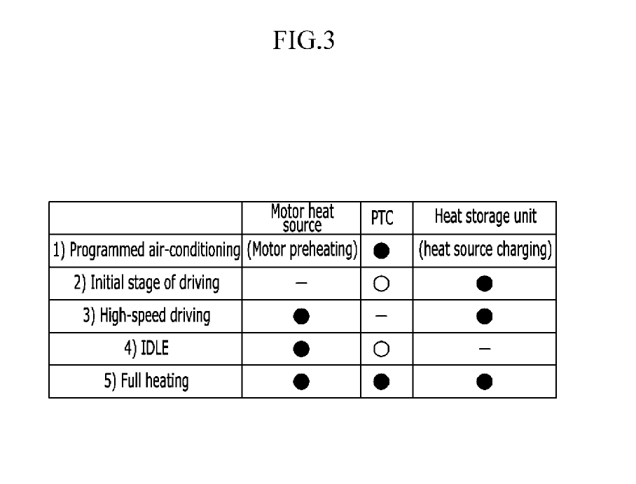

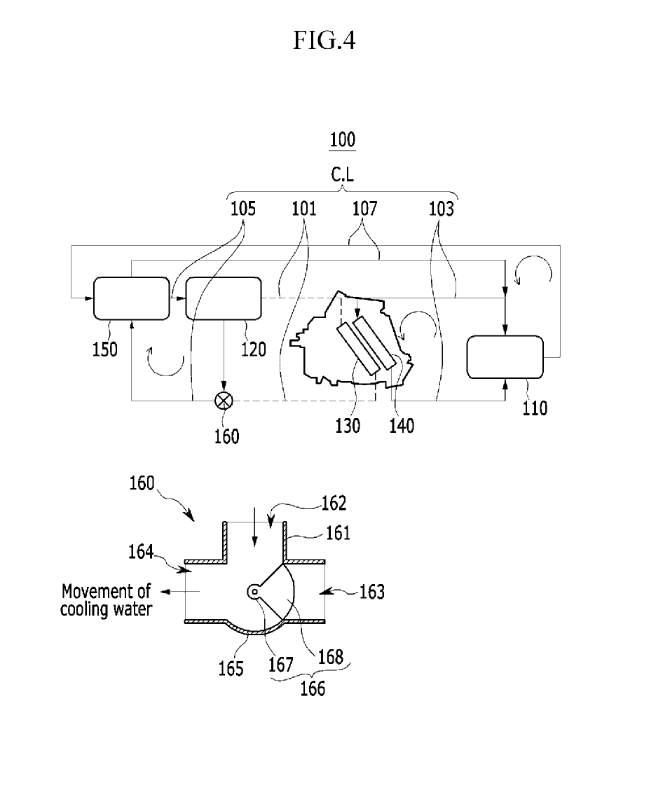

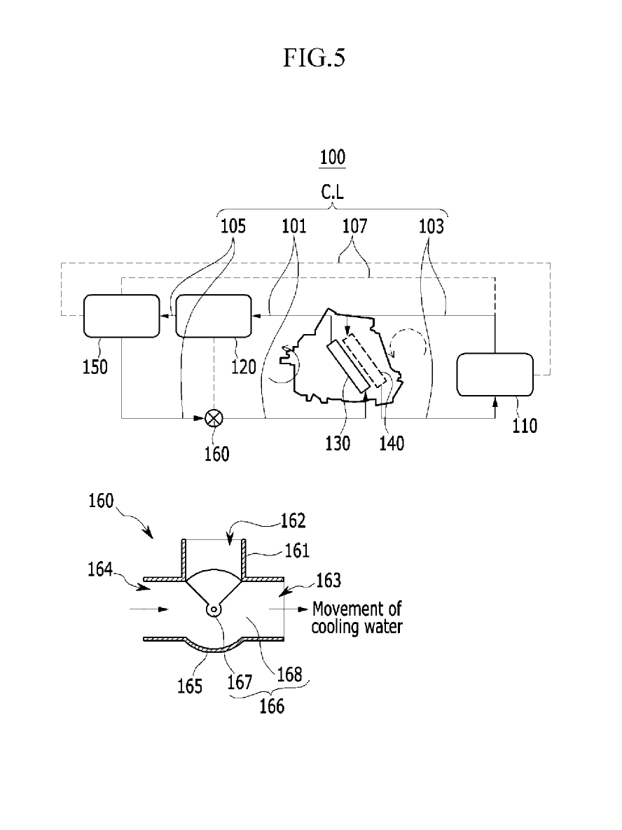

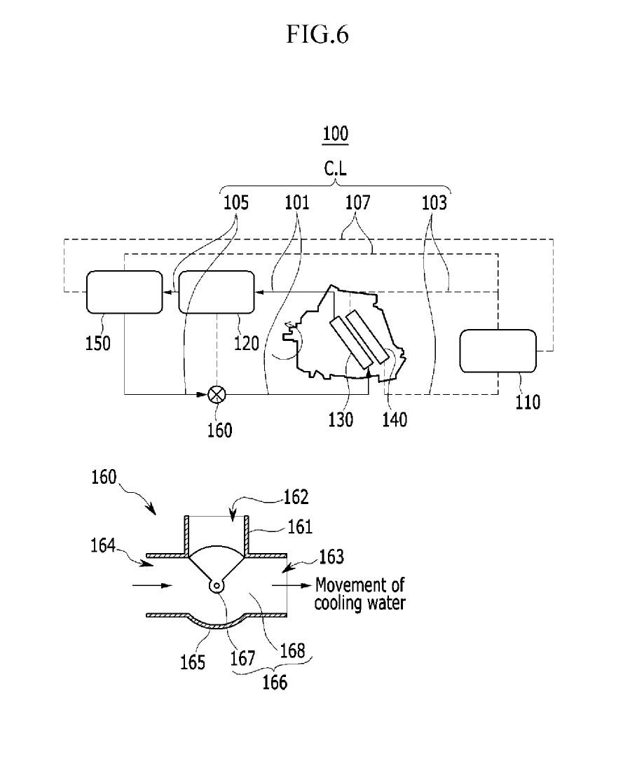

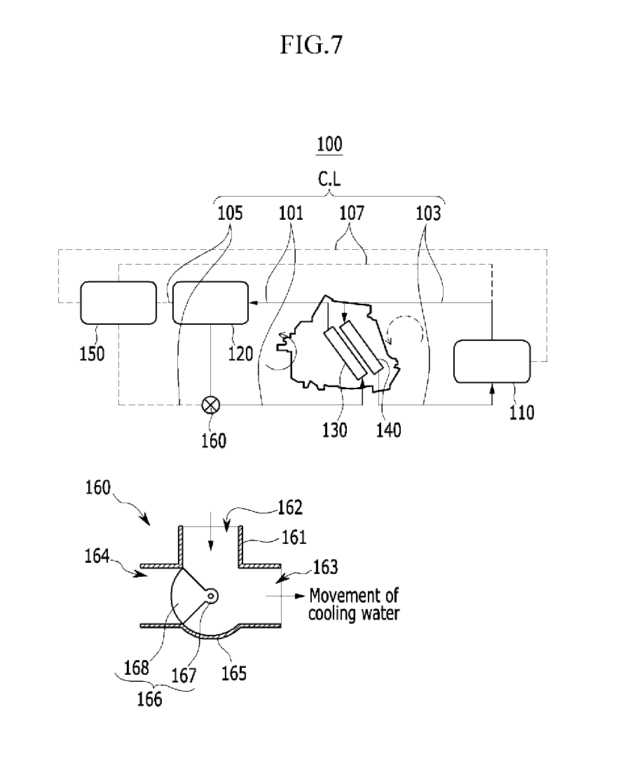

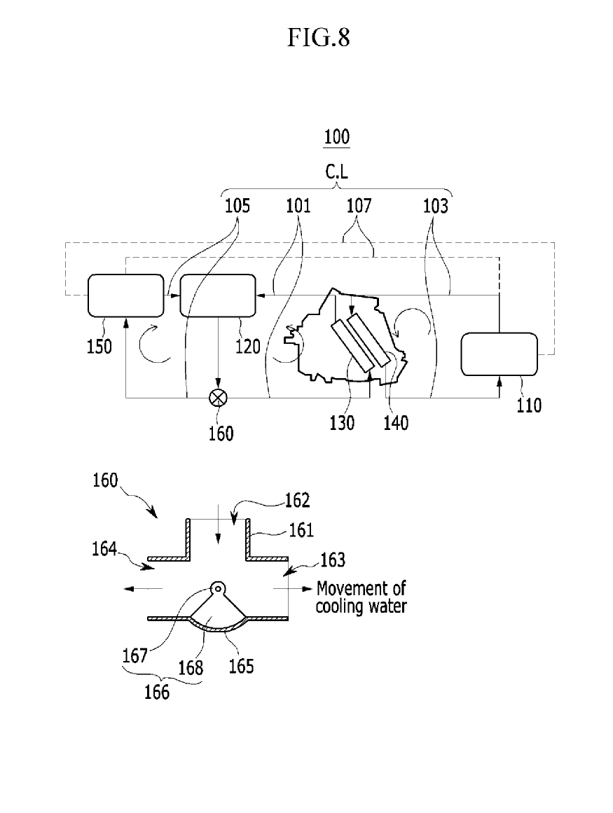

FIG. 3 is a table showing the operation of the heating system for the electric vehicle according to various embodiments of the present invention. FIG. 4 is a view showing the operating condition of the heating system for the electric vehicle according to various embodiments of the present invention during programmed air-conditioning. FIG. 5 is a view showing the operating condition of the heating system for the electric vehicle according to various embodiments of the present invention during the initial stage of driving. FIG. 6 is a view showing the operating condition of the heating system for the electric vehicle according to various embodiments of the present invention during high-speed driving. FIG. 7 is a view showing the operating condition of the heating system for the electric vehicle according to various embodiments of the present invention during IDLE. FIG. 8 is a view showing the operating condition of the heating system for the electric vehicle according to various embodiments of the present invention during full heating.

Referring to FIG. 3, operating modes of the heating system for the electric vehicle according to various embodiments of the present invention roughly include programmed air-conditioning, initial stage of driving, high-speed driving, IDLE, and full heating.

First of all, the programmed air-conditioning mode of the heating system 100 for the electric vehicle according to various embodiments of the present invention when the vehicle is in park will be described. As shown in FIG. 3 and FIG. 4, the opening and closing member 166 of the valve unit 160 rotates within the main body 161 and closes the second open hole 163 so that cooling water, with its temperature raised by the heat generated during the operation of the drive motor 120, circulates to the heat storage unit 150.

Accordingly, the cooling water, which has a raised temperature because it has cooled down the drive motor 120, circulates from the drive motor 120 to the heat storage unit 150 along the third line 105. Hereupon, the first line 101 is closed.

Meanwhile, the cooling water circulates between the PTC 140 and the battery 110 activated by power supply, along the second line 105.

In addition, the cooling water supplied to cool down the battery 110, which has a raised temperature after cooling down the battery 110, is supplied to the heat storage unit 150 along the fourth line 107.

In this case, the heat storage unit 150 receives thermal energy from the cooing water which circulates through the third line 105 and the fourth line 107 and whose temperature has risen by a waste heat source generated from the battery 110 and the drive motor 120, and stores heat from the received thermal energy.

A certain amount of thermal energy is lost as the cooling water, which is kept from circulating to the heating heat exchanger 130, passes through the heat storage unit 150. Thus, as the cooling water circulates through the third line 120, with the temperature maintained at a constant level, the drive motor 120 is preheated.

In the present exemplary embodiment, in the heating mode which uses the waste heat source of the drive motor 120 during initial stage of driving, the opening and closing member 166 of the valve unit 160 rotates within the main body 161 and closes the first open hole 161, as shown in FIG. 3 and FIG. 5.

Accordingly, the first line 101 and the third line 103 are interconnected, and the cooling water circulates among the drive motor 120, the heat storage unit 150, and the heating heat exchanger 130.

In this case, the PTC 140 acts as auxiliary means, if necessary, depending on the user's heating temperature setting. Once the PTC 140 is activated, the cooling water circulates through the second line 103 interconnecting the battery 110 and the PTC 140, and the waste heat generated from the battery 110 is used.

That is, the cooling water having a higher temperature by the thermal energy stored in the heat storage unit 150 is supplied, along with the cooling water with its temperature raised as it passes through the drive motor 120, to the heating heat exchanger 130, and the PTC 140 is activated if necessary.

Accordingly, outside air coming from the outside of the vehicle enters the inside of the vehicle, with its temperature raised by heat exchange as it passes through the heating heat exchanger 130 and PTC 140 with high-temperature cooling water introduced therein, and as a result, the inside of the vehicle is heated.

During highs-speed driving, different from the above-described the initial stage of driving, the heating system 100 works in a way that the opening and closing member 166 of the valve unit 160 rotates within the main body 161 and closes the first open hole 162, as shown in FIG. 3 and FIG. 6.

Accordingly, the first line 162 and the third line 164 are interconnected, and cooling water circulates among the drive motor 120, the heat storage unit 150, and the heating heat exchanger 130.

Unlike the above-described the initial stage of driving, the operation of the PTC 140 is stopped.

As the drive motor 120 is fully activated during high-speed driving, the amount of heat generation increases. Consequently, the cooling water is maintained sufficiently high, and the inside of the vehicle can be heated enough by the waste heat in the cooling water and the thermal energy stored in the heat storage unit 150.

Accordingly, the cooling water, whose temperature has risen after cooling down the drive motor 120 that has reached the maximum amount of heat generation, is supplied to the heating heat exchanger 130, and the outside air coming from the outside of the vehicle enters the inside of the vehicle, with its temperature raised by heat exchange as it passes through the heating heat exchanger 130 with high-temperature cooling water introduced therein, and as a result, the inside of the vehicle is heated.

Meanwhile, during the above-described initial stage of driving and the above-described high-speed driving, the heating system 100 works in a way that the fourth line 107 interconnecting the battery 110 and the heat storage unit 150 is kept closed, thereby preventing the cooling water having passed through the battery 110 from circulating to the heat storage unit 150.

In the present exemplary embodiment, during IDLE, the heating system 100 works in a way that the opening and closing member 166 of the valve unit 160 rotates within the main body 161 and closes the third open hole 164, as shown in FIG. 3 and FIG. 7.

Accordingly, the third line 105 connected to the heat storage unit 150 is closed, and cooling water enters the heating heat exchanger 130, with its temperature raised as it passes through the driving motor 120 through the first line 101.

In this case, the PTC 140 acts as auxiliary means, if necessary, depending on the user's heating temperature setting. Once the PTC 140 is activated, the cooling water circulates through the second line 103 interconnecting the battery 110 and the PTC 140, and the waste heat generated from the battery 110 is used.

That is, similarly to the heating mode during the initial stage of driving, the cooling water with its temperature raised as it passes through the drive motor 120 is supplied to the heating heat exchanger 130, and the PTC 140 is activated if necessary.

Accordingly, outside air coming from the outside of the vehicle enters the inside of the vehicle, with its temperature raised by heat exchange as it passes through the heating heat exchanger 130 and PTC 140 with high-temperature cooling water introduced therein, and as a result, the inside of the vehicle is heated.

Lastly, when fully heating the vehicle while driving, the heating system 100 works in a way that the opening and closing member 166 of the valve unit 160 rotates within the main body 161 and is situated on the rounded part 165, thereby opening all of the open holes 162, 163, and 164, as shown in FIG. 3 and FIG. 8.

Accordingly, the cooling water enters the heating heat exchanger 130, with its temperature raised as it passes through the drive motor 120 through the first line 101, and at the same time is circulated to the drive motor 120 and the heat storage unit 150 through the third line 105, thereby making use of the thermal energy stored in the heat storage unit 150.

In this case, the PTC 140 is fully activated according to the full heating mode. Once the PTC 140 is activated, the cooling water circulates through the second line 103 interconnecting the battery 110 and the PTC 140, and the waste heat generated from the battery 110 is used.

As full heating requires the maximum use of heat sources, the waste heat generated from the drive motor 120, the thermal energy stored in the heat storage unit 150, and the PTC 140 are used altogether so that the outside air coming from the outside of the vehicle is raised as high as possible and introduced to the inside.

Meanwhile, during the above-described IDLE condition and the above-described full heating, the heating system 100 works in a way that the fourth line 107 interconnecting the battery 110 and the heat storage unit 150 is kept closed, thereby preventing the cooling water having passed through the battery 110 from circulating to the heat storage unit 150.

Accordingly, the heating system 100 for the electric vehicle according to the present exemplary embodiment stores thermal energy from the waste heat generated from the battery 110 and the drive motor 120 by means of the heat storage unit 150 when the vehicle is in park, and the stored thermal energy is optionally used for heating the vehicle depending on the vehicle state.

Therefore, the thus-configured heating system 120 for the electric vehicle according to various embodiments of the present invention can improve the overall heating efficiency of the electric vehicle by storing the heat of cooling water having a raised temperature due to the drive motor 120, and selectively supplying the heat to the heating heat exchanger 130 for use in heating, depending on the vehicle's driving condition and which mode the user selects.

In addition, the use of the heat stored in the heat storage unit 150 simplifies the entire system by reducing the components, cuts down on manufacturing costs, and prevents unnecessary power use, even without including an auxiliary heater, thereby improving the overall fuel rate and driving distance of the electric vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heating system for an electric vehicle heats the inside of the electric vehicle running by the driving force of a drive motor activated by power supplied from a battery, the heating system comprising:
a heating heat exchanger connected to the drive motor via a cooling line through which cooling water circulates between the battery and the drive motor;
a positive temperature coefficient heater (PTC) connected to the battery via the cooling line and activated by the power of the battery;
a heat storage unit that collects and stores thermal energy from the cooling water, with its temperature raised while cooling down the drive motor, and connected in series to the drive motor and the battery via the cooling line; and
a valve unit installed in the cooling line interconnecting the drive motor, the heating heat exchanger, and the heat storage unit, wherein the valve unit selectively connects the cooling line to the drive motor, the heating heat exchanger, and the heat storage unit by opening and closing operations.

2. The heating system of claim 1, wherein the cooling line comprises:
a first line connected to the valve unit and interconnects the drive motor and the heating heat exchanger;
a second line that interconnects the battery and the PTC;
a third line connected to the valve unit and interconnects the drive motor and the heat storage unit; and
a fourth line that interconnects the battery and the heat storage unit.

3. The heating system of claim 2, wherein the valve unit consists of a 3-way valve that interconnects the first line and the third line.

4. The heating system of claim 2, wherein the valve unit comprises:
a main body including a first open hole connected to the drive motor through the first line so as to be connected to the drive motor, the heating heat exchanger, and the heat storage unit, a second open hole connected to the heating heat exchanger through the second line, and a third open hole connected to the heat storage unit through the third line; and
an opening and closing member rotatably configured to selectively open and close the open holes within the main body.

5. The heating system of claim 4, wherein the second open hole and the third open hole are positioned on both ends of the main body, and the first open hole are positioned at a middle portion of the main body, between the first open hole and the third open hole.

6. The heating system of claim 4, wherein
the opening and closing member comprises:
a rotation part rotatably formed in the middle within the main body; and
a fan-shaped opening and closing part, one edge of which is connected integrally to a side of the rotation part, and an other edge of which selectively opens and closes the open holes.

7. The heating system of claim 5, wherein a rounded part disposed on the opposite side of the first open hole, corresponding to an other edge of the opening and closing part, is formed integrally with the main body.

8. The heating system of claim 5, wherein a lateral length D of the other edge of the opening and closing part is equal to a width W of the opening holes (D=W).
